(19) United States
(12) Patent Application Publication
(10) Pub. No.: US 2006/0041621 A1
(43) Pub. Date: Feb. 23, 2006

(54) Method and system for providing a disposable email address

(75) Inventor: Miles Libbey, Mountain View, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 10/850,642

(22) Filed: May 21, 2004

(51) Int. Cl. G06F 15/16

(52) U.S. Cl. 709/206

(57) ABSTRACT

A method, apparatus, and system are directed towards providing a Disposable Email Address (DEA) that may be employed, in part, to manage email spam. The DEA may be generated based, in part, on an end-user profile, a keyword, and a domain address. The DEA may be distinguishable from a non-DEA by a selection of at least one preserved character, such as a dash. Moreover, the DEA may be discarded at some time later, without affecting an end-user's ‘permanent’ email address.

### FIELD OF THE INVENTION

The present invention relates generally to messaging systems, and more particularly to determining a disposable email address to reduce undesired messages.

### BACKGROUND OF THE INVENTION

Today, one's email address is a highly sought after commodity. Access to one's email address enables another to send them a newsletter, an advertisement, a friendly email, a complaint, and the like. Access to one's email address may be freely provided. For example, one may provide the email address to another that they desire to receive email from, including a friend, business associate, business, organization, family member, and the like. However, one may also receive non-solicited email from businesses, ex-friends, unauthorized senders, and the like.

Access to one's email address may be obtained through a variety of other ways, including, when one places an order for an item over the Internet, responds to an advertisement, provides a business card, completes a form requesting one's email address, archives a message such as in a publicly accessible archive, web page, and the like. Sometimes, businesses employ email address generators that attempt to guess one's email address.

Often, once a business does obtain an email address, they may sell it, trade it, and the like, to another business. The business may even republish the email address. This exchange may result in one's email address being added to a spam list, or other unauthorized email lists. In other situations, a business may not manage its list of email addresses in a secure manner. Under these situations, a hacker may locate the list of email addresses, with the result of one's email address again being added to an unauthorized list. Thus, there is a need in the industry to enable one to better manage access to their email address. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a server device that may be included in a system implementing the invention;

FIG. 3 illustrates a logical flow diagram generally showing one embodiment of a process for generating a disposable email address; and

FIG. 4 illustrates a logical flow diagram generally showing one embodiment of a process for managing an inbound email, in accordance with the present invention.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The terms “comprising,” “including,” “containing,” “having,” and “characterized by,” refer to an open-ended or inclusive transitional construct and does not exclude additional, unrecited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

The term “or” is an inclusive “or” operator, and includes the term “and/or,” unless the context clearly dictates otherwise.

The phrase “in one embodiment,” as used herein does not necessarily refer to the same embodiment, although it may.

The term “based on” is not exclusive and provides for being based on additional factors not described, unless the context clearly dictates otherwise.

Briefly stated, the present invention is directed towards providing a system, apparatus, and method for managing email spam, and the like, through the use of a Disposable Email Address (DEA). The DEA may be generated based, in part, on a user profile, a keyword, a domain address, and the like. In one embodiment, the DEA is distinguishable from a non-DEA by a selection of at least one preserved character, such as a dash, that may be employed as a separator, or the like, between the profile and keyword. An end-user may generate a plurality of DEAs by varying the keyword. In one embodiment, the DEA may be employed to send the end-user messages from a plurality of other end-users. Generation of the DEA may also be automatic based on receiving an email, completing a webpage form, or the like. In one embodiment, the DEA may be created by employing a toolbar, such as a companion toolbar, and the like. The toolbar may be configured to be readily accessible from within virtually any other program, including, but not limited to a web browser. The DEAs may be filtered, routed to a folder within the end-user's mailbox, and the like. Moreover, the DEA may be discarded at some time later, without affecting an end-user's ‘permanent’ email address.

Illustrative Operating Environment

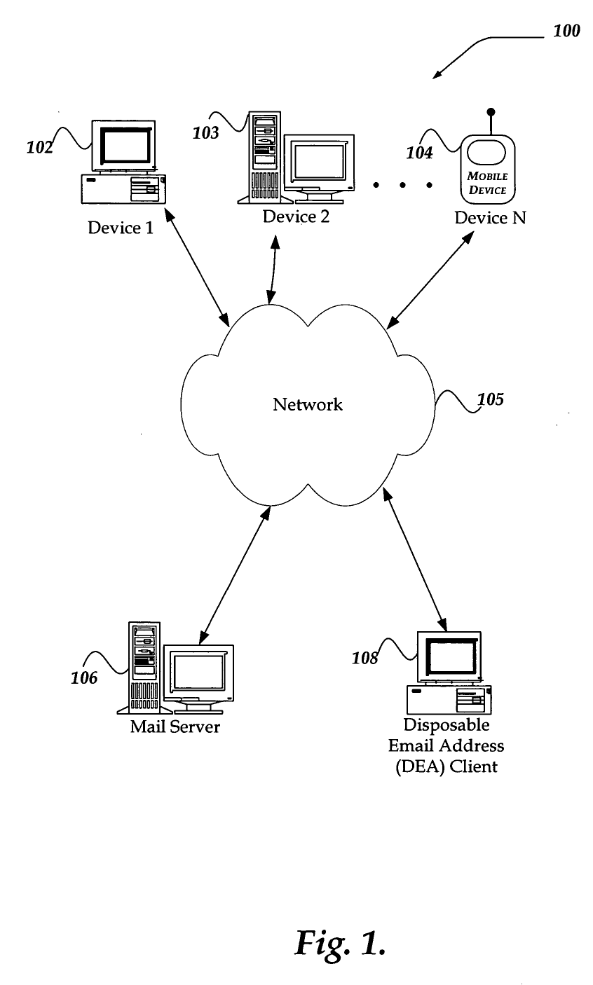

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, system 100 includes devices 102-104, network 105, mail server 106, and Disposable Email Address (DEA) device 108. Network 105 is in communication with and enables communication between each of devices 102-104, mail server 106, and DEA device 108.

Devices 102-104 may include virtually any computing device capable of receiving and sending a packet over a network, such as network 105, to and from another computing device, such as mail server 106 and DEA 108. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, and the like. Alternatively, devices 102-104 may be any device that is capable of connecting using a wired or wireless communication medium such as a PDA, POCKET PC, wearable computer, and any other device that is equipped to communicate over a wired and/or wireless communication medium.

In one embodiment, at least one device within devices 102-104 may be configured to operate as a website, a File System, a File Transfer Protocol (FTP) server, another mail server, a Network News Transfer Protocol (NNTP) server, and the like. In another embodiment, at least one device within devices 102-104 may operate to provide a website that DEA device 108 may desire to access. At least one device within devices 102-104 may further arrange a webpage, and the like, to request an email address from an end-user of DEA device 108.

In one embodiment, devices 102-104 may employ a list of email addresses to send messages to members of the list. The messages may include solicitations, news, advertisements, spam, and the like. Membership on the list may have been sought by a member on the list. A member on the list may also not wish to maintain membership on the list. In at least one embodiment, it may be difficult for a member to have its email address deleted from the list of email addresses.

Devices 102-104 may also operate as a personal computing device enabled to send and receive email messages. For example, device 102 may be a personal computer that enables a friend, associate, family member, business, organization, and the like, to send and receive email to the end-user of DEA device 108. As such, devices 102-104 may include a mail transfer agent (MTA), such as sendmail, and the like. Devices 102-104 may also include a mail user agent (MUA) such as Elm, Pine, MR, Outlook, and the like.

Network 105 is configured to couple one computing device to another computing device to enable them to communicate. Network 105 is enabled to employ any form of computer readable media for communicating information from one electronic device to another. Also, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between devices 102-104, mail server 106, and DEA device 108.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

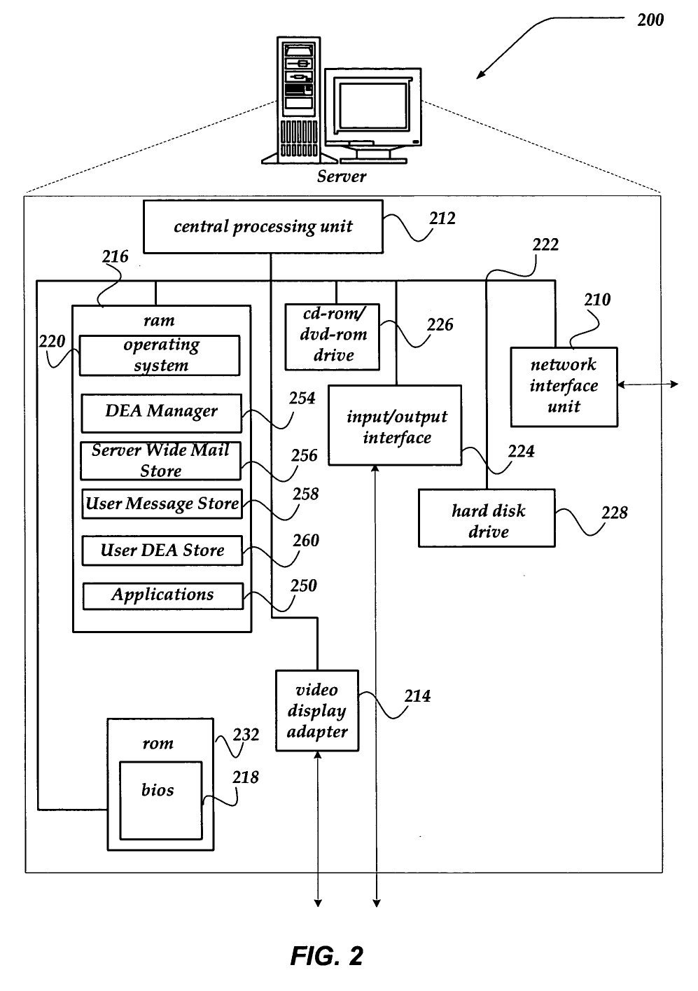

One embodiment of mail server 106 is described in more detail below in conjunction with FIG. 2. Briefly, however, mail server 106 may include any computing device capable of connecting to DEA device 108, to manage an electronic mail (email) service for DEA device 108. Mail server 106 may thus include a message transfer manager to communicate a message employing any of a variety of email protocols, including, but not limited, to Simple Mail Transfer Protocol (SMTP), Post Office Protocol (POP), Internet Message Access Protocol (IMAP), NNTP, and the like.

Devices that may operate as mail server 106 include personal computers desktop computers, multiprocessor systems, microprocessor-based or programmable consumer electronics, network PCs, servers, and the like.

Mail server 106 may further include databases, files, and the like, that are arranged to store a received email message until accessed by a computing device, such as DEA device 108. Mail server 106 may further include a program that enable filtering of an email message, based, in part, on any of a variety of characteristics, including an email address associated with the email message. Mail server 106 may manage email messages for another computing device in addition to DEA device 108.

DEA device 108 may include virtually any computing device capable of receiving and sending a packet over a network, such as network 105, to and from another computing device, such as mail server 106 and devices 102-104. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, and the like. DEA device 108 may also be any device that is capable of connecting using a wired or wireless communication medium such as a PDA, POCKET PC, wearable computer, and any other device that is equipped to communicate over a wired and/or wireless communication medium.

DEA device 108 may be configured to employ mail server 106 as its mail server. DEA device 108 may have an email address assigned to it, based on a variety of characteristics, including a domain name associated with its Internet Service Provider (ISP), mail server, and the like.

DEA device 108 may include a DEA client application that is enabled to manage actions pertaining at least to the DEA. For example, the DEA client may be configured to employ a disposable email address (DEA), described in more detail below, to receive and send an email message. The DEA client may employ mail server 106 to generate, configure, and maintain the DEA. DEA client may employ a toolbar, accessible from within virtually any application, and the like, to assist in the generation, configuration, and maintenance of the DEA. The DEA client may further employ a plurality of DEAs, as well as a ‘permanent’ email address to send and receive email messages. The DEA client may employ mail server 106 to filter a DEA based on a pre-determined characteristic of the DEA, as well as color code a DEA, direct a DEA to a pre-determined folder associated with its MUA, and the like. The DEA client of DEA device 108 may further delete a DEA such that email messages are not receivable through that DEA.

Illustrative Server Environment

FIG. 2 shows one embodiment of a server, according to one embodiment of the invention. Server 200 may include many more components than those shown. The components shown, however, are sufficient to disclose an illustrative embodiment for practicing the invention.

Server 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of server 102. Any general-purpose operating system may be employed. Basic input/output system (“BIOS”) 218 is also provided for controlling the low-level operation of server 102. As illustrated in FIG. 2, server 200 also can communicate with the Internet, or some other communications network, such as network 105 in FIG. 1, via network interface unit 210, which is constructed for use with various communication protocols including the TCP/IP protocol. Network interface unit 210 is sometimes known as a transceiver, transceiving device, network interface card (NIC), and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs include email programs, schedulers, calendars, transcoders, contact database programs, word processing programs, spreadsheet programs, and so forth. Mass storage may further include applications such as DEA manager 254, server wide mail store 256, user message store 258, user DEA store 260, and the like.

DEA manager 254 may include virtually any program or set of programs that are configured to generate and manage a DEA for each end-user associated a selected the email service. For example, DEA manager 254 may employ a toolbar, such as a companion toolbar, and the like, to provide access to each end-user to generate and manage the DEA. However, the invention is not so limited, and DEA manager 254 may employ virtually any client-side application from which to create a disposable email address, including, but not limited to, a word processing application, a spread-sheet application, instant messenger application, browser, and the like.

DEA manager 254 may employ server wide mail store 256 to store email messages, attachments, and the like, for each end-user. DEA manager 254 may further employ server wide mail store 256 to store and manage a profile and related property preferences associated with an end-user.

DEA manager 254 may further partition, filter, and the like, email messages per end-user, whether the email is a DEA message, non-DEA message, and the like, and store the messages in user message store 258, user DEA store 260, and the like.

DEA manager 254 may further employ user message 258 to store and manage information related to a user, including settings, location of an end-user's inbox, and the like. DEA manager 254 may also employ user DEA store 260 to store and manager a keyword, filter, and the like, associated with a DEA for an end-user.

Although, user message store 258 and user DEA store 260 are illustrated on server 200, the invention is not so limited. For example, user message store 258 and/or user DEA store 260 may reside on DEA device 108 of FIG. 1, without departing from the scope of the present invention. In one embodiment, user DEA store 260 may be implemented as a folder accessible by a MUA residing on DEA device 108 of FIG. 1.

DEA manager 254 may further include a dictionary attack detector and the like, that is enabled to monitor for potential security attacks. In one embodiment, the dictionary attack detector determines if a potential attack is based on trying various combinations of words, characters, and the like, in an attempt to identify a DEA, non-DEA address, and the like. If an attack is detected, DEA manager 254 may respond by sending a busy signal to the potential attacker, deny a connection with the potential attacker, and the like. DEA manager 254 may further send an alert to an administrator, authority, and the like, regarding the detected attack.

DEA manager 254 is not limited to monitoring solely for dictionary attacks, and may employ any of a variety of other security mechanisms to detect a potential hacker searching for access to a DEA, non-DEA, and the like, without departing from the scope of the invention.

Server 200 may also include an SMTP handler application to interface with DEA manager 254 for transmitting and receiving email. Server 200 may also include an HTTP handler application for receiving and handing HTTP requests, and an HTTPS handler application for handling secure connections. The HTTPS handler application may initiate communication with an external application in a secure fashion.

Server 200 also includes input/output interface 224 for communicating with external devices, such as a mouse, keyboard, scanner, or other input devices not shown in FIG. 2. Likewise, server 200 may further include additional mass storage facilities such as CD-ROM/DVD-ROM drive 226 and hard disk drive 228. Hard disk drive 228 is utilized by server 102 to store, among other things, application programs, databases, server wide mail store 256, user message store 258, user DEA store 260, and the like.

Generalized Operation

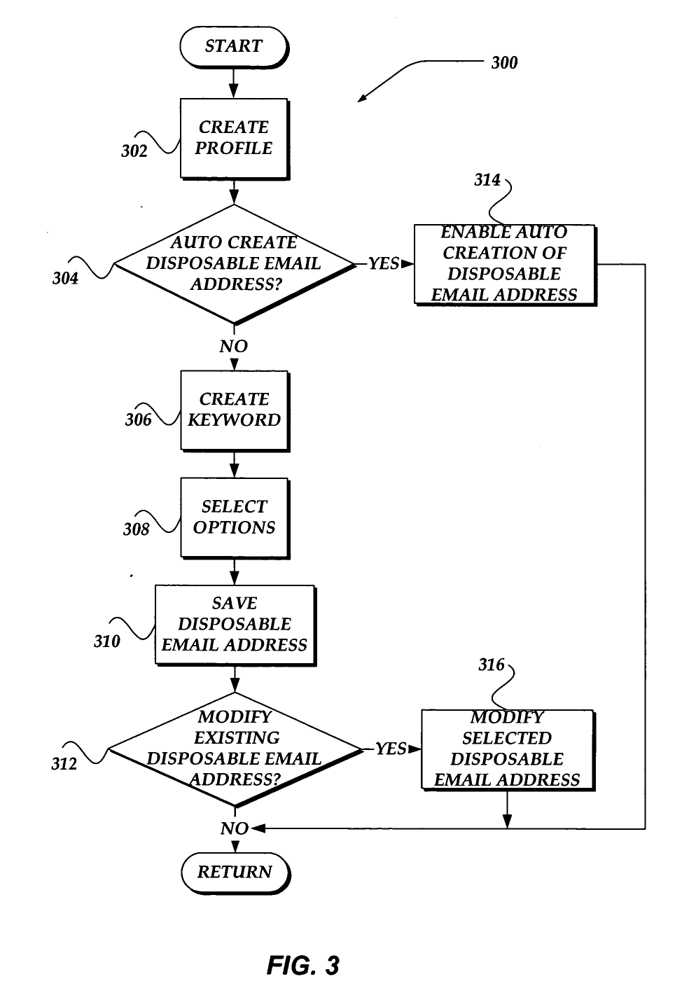

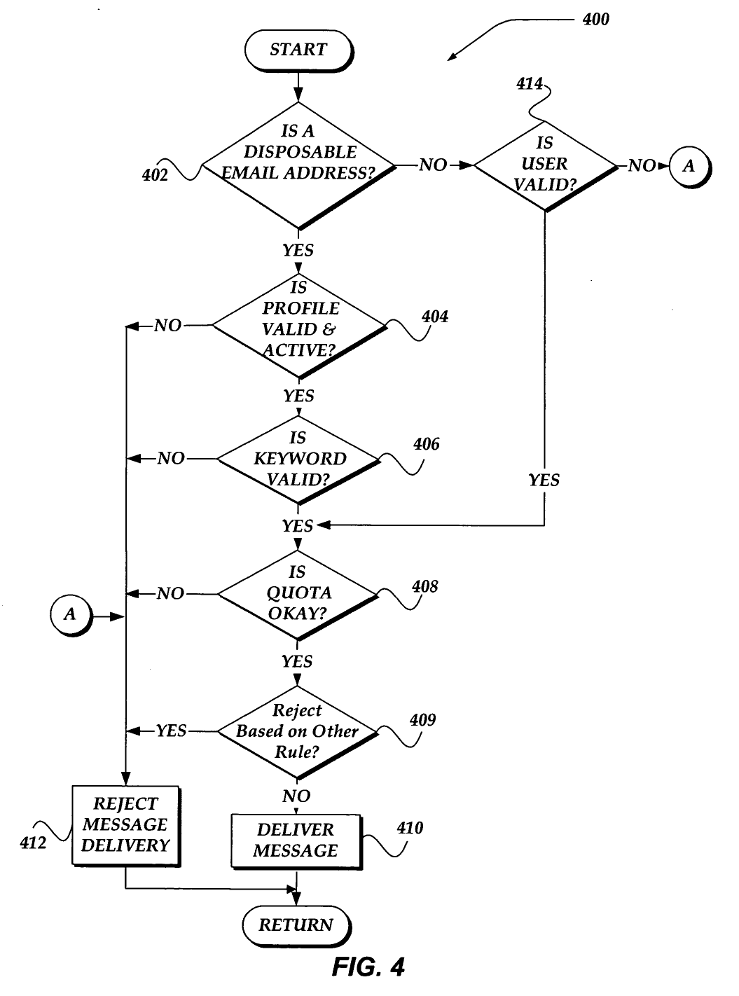

The operation of certain aspects of the present invention will now be described with respect to FIGS. 3-4. FIG. 3 illustrates a logical flow diagram generally showing one embodiment of a process for generating a disposable email address. DEA generation process 300 may be implemented within mail server 106 and be accessible by DEA device 108 of FIG. 1.

In one embodiment, a disposable email address (DEA) is formatted in a structure that includes a unique profile associated with an end-user account, a keyword, and a domain address. Additionally, the DEA may include a preserved character, or set of characters that identity the email address as a disposable email address. In one embodiment, the preserved character is a dash (-); however, the invention is not so limited. For example, the preserved character may include virtually any character, such as an asterisk, a pound, even a sequence of characters, such as “DEA,” and the like, without departing from the scope of the invention.

One example of a possible DEA format may include profile-keyword@yahoo.com, where yahoo.com is a domain address.

Moreover, the DEA may be used to receive messages from multiple sources, and need not be dedicated to a single recipient.

DEA generation process 300 begins, after a start block, at block 302, where a unique profile is created for an end-user account. An end-user may log into its mail server to generate the profile. However, the invention is not so limited. For example, a unique profile may automatically be generated for each end-user account associated with the mail server.

The profile may typically include virtually any unique identifier associated with the end-user account. For example, the profile may include a sequence of characters associated with the end-user's mailbox for the end-user's account, name associated with the end-user's account, and the like. For example, one possible profile may include a unique abbreviation of the end-user's name associated with the end-user's account.

Processing next proceeds to decision block 304, where a determination is made whether the DEA is to be auto created. For example, the end-user may have entered wish to provide a DEA in response to request on a current webpage, email, and the like. In any event, if auto creation of a DEA is desired, the process branches to block 314; otherwise, it continues to block 306.

At block 314, auto creation of a DEA is enabled. Auto creation of a DEA may include selection of a keyword associated with a webpage, domain address, email sender, email subject, and the like. Auto creation may further randomly select a keyword based on any of a variety of mechanisms. Auto creation may further employ a set of default, or pre-determined options arranged to manage the DEA. Upon completion of block 314, the DEA generation process returns to a calling process to perform other actions.

At block 306, a keyword is created. The keyword may be selected by the user based on any of a variety of mechanisms, including, but not limited to, a name of a sender, a business event, a firm name, and the like. The keyword may for example, include a descriptor of an event, such as “birthdaypartyforJohn,” and the like. The keyword may also be selected to categorize emailers, such as “localfriend,” “companyassociate,” “girlfriend,” “buddylistforpoker,” and the like. There is virtually no limit to the possible keywords that may be selected. Additionally, in part, because the DEA employs a unique profile, keywords need not be unique to an end-user. That is, multiple end-users may even employ substantially similar, if not identical keywords in a DEA.

Processing next flows to block 308 where options for use of the DEA are selected. Selected options include, but are not limited to, generating folders for the DEA to be delivered to, configuring a spam protector, filter, and the like, color coding headers and the like associated with the DEA, enabling a counter associated with the DEA, a statistical analysis program, and the like. Upon completion of block 308, processing moves to block 310, where the DEA and its associated selected options are saved for use.

Processing flows next to decision block 312 where a determination is made whether an existing DEA is to be modified. Modification of an existing DEA may include deleting the DEA, modifying selected options associated with the DEA, and the like. If an existing DEA is to be modified, processing proceeds to block 316 where the modifications are performed. Upon completion of block 316, processing returns to the calling process to perform other actions. If no existing DEA is to be modified, processing returns to the calling process to perform other actions.

FIG. 4 illustrates a logical flow diagram generally showing one embodiment of a process for managing an inbound email, in accordance with the present invention. Process 400 may be implemented in mail server 106 of FIG. 1.

Process 400 begins, after a start block, at decision block 402, where a determination is made whether the inbound email is for a DEA. The determination may be based on the presence of a preserved character, set of characters, and the like. In one embodiment, the preserved character is a dash (“-”). In any event, if the inbound email is for a DEA, processing flows to decision block 404; otherwise, processing flows to decision block 414.

At decision block 414, a determination is made whether the email address for the non-DEA is for a valid user. That is, decision block 414, may include a typical analysis of the email address associated with the inbound email. If it is determined that the email address is not associated with a valid user managed by the mail server, processing proceeds to block 412; otherwise, processing continues to decision block 408.

At decision block 404, a determination is made whether the profile associated with the DEA is valid and active. Validity may be determined by searching a data store, and the like, for a match to the profile. If no match is located, an assumption may be made that the DEA is invalid and should be rejected. If the profile is determined to be invalid and/or inactive, processing branches to block 412, where the inbound email associated with the DEA is rejected. If a match is located, indicating a valid and active profile, processing proceeds to decision block 406.

At block 412, a determination may be made whether the associated DEA is an attempt for a hack, in which instance, a hack detector, and the like, may be employed. Upon completion of block 412, processing returns to a calling process to perform other actions.

At decision block 406, a determination is made whether the keyword associated with the DEA is valid. In one embodiment, a data store, and the like, for the valid profile, may be searched for a match. If a match is not located for the keyword, processing branches to block 412, described above; otherwise, processing proceeds to decision block 408.

At decision block 408, a determination is made whether a quota associated with a destination for the inbound email is satisfied. For example, in one embodiment, the quota is satisfied when a capacity associated with a destination inbox is exceeded. In any event, if it is determined that the quota is exceeded (that is, is not okay), processing proceeds to block 412, described above; otherwise, processing proceeds to decision block 409.

At decision block 409, a determination is made whether this DEA is to be rejected based on another rule. A DEA may be rejected for any of a variety of other rules. For example, a DEA may automatically expire after a predetermined period or number of emails received based, in part, on the DEA. The DEA may be restricted to a predetermined sender, list of senders, a trusted source, a verified source, or the like. Moreover, the DEA may be rejected based on a detection of a dictionary attack, is deemed untrustworthy, potentially spam, or the like. Virtually any rule may be employed to determine whether to reject the DEA. If the DEA is rejected, processing branches to block 412; however, if the DEA is not rejected based on another rule, processing proceeds to block 410.

At block 410, the inbound email is delivered based on the determined address, and if it is for a DEA, on the selected options. Upon completion of process 400, processing may return to the calling process to perform other actions. It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

We claim:

1. A method of managing a message over a network, comprising:
determining at least one disposable email address, wherein the at least one disposable email address is discardable at some later time;
selecting an option associated with the at least one disposable email address; and
if the message is associated with at least one disposable email address, routing the message to the at least one disposable email address based on the selected option.

2. The method of claim 1, wherein determining the at least one disposable email address further comprises:
creating a profile associated with an end-user account;
creating a keyword for each disposable email address; and
combining the profile, and the keyword with a domain address to provide the at least one disposable email address.

3. The method of claim 1, wherein determining the at least one disposable email address further comprises associating at least one preserved character with the at least one disposable email address, wherein the at least one preserved character enables identification that an email address is disposable.

4. The method of claim 1, wherein the at least one preserved character further comprises a dash (“-”).

5. The method of claim 1, wherein selecting an option further comprises, selecting at least one of a folder, a configuration for a message filter, a color coding, a counter, and an analysis program.

6. The method of claim 1, wherein determining the at least one disposable email address further comprises automatically creating the at least one disposable email address based, in part, on a profile associated with an end-user account.

7. The method of claim 1, further comprising modifying the option associated with the at least one disposable email address.

8. The method of claim 1, further comprising deleting the at least one disposable email address such that another message using the deleted disposable email address is rejected.

9. The method of claim 1, further comprising:
receiving another message; and
if the other message is associated with at least one disposable email address,
determining if the associated disposable email address is a valid disposable email address, and
if the associated disposable email address is valid, delivering the other message based on the associated disposable email address.

10. The method of claim 1, wherein receiving the message further comprises determining if the message is associated with at least one disposable email address based, in part, on determining a presence of at least one preserved character in an email address associated with the message.

11. The method of claim 1, further comprising employing the at least one disposable email address to send another message.

12. The method of claim 1, wherein determining at least one disposable email address further comprises determining the at least one disposable email address by accessing a toolbar.

13. The method of claim 12, wherein accessing the toolbar further comprises accessing the toolbar while within another program.

14. The method of claim 1, wherein determining at least one disposable email address further comprises determining the at least one disposable email address by employing an instant messenger chat window.

15. The method of claim 1, wherein the at least one disposable email address is employable to receive the message from a first source and to receive another message from a second source.

16. A client adapted to managing a message over a network, the client being configured to perform actions, comprising:
logging into a server;
determining a profile associated with an end-user account;
determining a keyword, wherein the profile and keyword are combinable with a domain address to determine a disposable email address; and
employing the disposable email address to receive the message.

17. The client of claim 16, wherein the client is configured to perform further actions, comprising: selecting at least one option associated with the disposable email address.

18. The client of claim 17, wherein the at least one option is selected from at least one of determining a folder to associate with the disposable email address, determining a configuration for a span filter, determining a color coding, a counter, and an analysis program.

19. The client of claim 16, wherein the client is configured to perform further actions, comprising: deleting the disposable email address such that another message is rejected.

20. The client of claim 16, wherein the client is configured to perform further actions, comprising: enabling auto creation of the disposable email address.

21. The client of claim 16, wherein receiving the message further comprises determining if the message is using at least one disposable email address based, in part, on at least one preserved character associated with the disposable email address.

22. The client of claim 16, wherein the client is adapted to operate within a mobile device.

23. A server for managing a message over a network, comprising:
a transceiver for receiving and sending messages to a computing device; and
a transcoder that is configured to perform actions, including:
receiving a request for a disposable email address;
in response to the request, determining the disposable email address, in part, by combining a profile and a keyword with a domain name address; and
if the message employs the disposable email address, routing the message based, in part, on the disposable email address.

24. The server of claim 23, wherein the profile further comprises at least one of a mailbox identifier, and an account identifier.

25. The server of claim 23, wherein the disposable email address further comprises at least one preserved character that enables identification of an email address as disposable.

26. The server of claim 23, wherein the disposable email address is employable to receive the message from a first source and to receive another message from a second source.

27. A system for managing a message over a network comprising:
a client computing device that is configured to perform actions, comprising:
sending a request for a disposable email address;
selecting a keyword associated with the disposable email address; and
selecting at least one option associated with the use of the disposable email address; and
a mail service, coupled to the client computing device, that is configured to perform actions, comprising:
receiving the request for the disposable email address;
receiving the selected keyword;
determining a profile associated with an end-user account;
determining the disposable email address by combining the profile and the keyword with a domain address associated with the mail service; and
if the message is associated with the disposable email address, routing the message to the disposable email address based on the at least one selected option.

28. The system of claim 27, wherein determining the disposable email address further comprises combining the profile, the keyword and the domain address with at least one preserved character that enables identification that an email address is disposable.

29. The system of claim 27, wherein the client computing device is further configured to request deletion of the disposable email address such that another message associated with the deleted disposable email address is rejected.

30. The system of claim 27, wherein the client computing device is a mobile computing device.

31. The system of claim 27, further comprising:
receiving another message associated with another disposable email address, and determining if the other disposable email address is an invalid disposable email address based on at least one of an invalid profile, an invalid keyword, and a quota that is exceeded.

32. A modulated data signal for managing a message over a network, the modulated data signal comprising the actions of:
receiving a request for a disposable email address;
receiving a keyword;
in response to the request, determining the disposable email address, in part, by combining a profile and the keyword with a domain name address; and
if the message employs the disposable email address, routing the message based, in part, on the disposable email address.

33. The modulated data signal of claim 32, wherein routing the message further comprises routing the message based in part on a quota associated with the disposable email address.

34. The modulated data signal of claim 32, further comprising:
selecting at least one option associated with the disposable email address; and
routing the message further based on the at least one selected option.

35. A computer-readable medium having stored thereon a data structure for managing a message over a network, comprising:
a first data field including a profile associated with a end-user account;
a second data field including at least one preserved character that is configured to identify the data structure as a disposable email address;
a third data field including a keyword; and
a fourth data field including a domain address, wherein the first data field, second data field, third data field, and fourth data field together comprise the disposable email address, the disposable email address being employable to receive the message from a first source and another message from a second source.

36. The computer-readable medium of claim 35, wherein the data structure is generated, in part, by accessing a companion toolbar.

37. An apparatus for managing a message over a network, comprising:
a means for receiving a request for a disposable email address;
a means for receiving a selected keyword;
a means for determining a profile associated with the request;
a means for combining the profile and the keyword with a domain address associated with the mail service to provide the disposable email address; and
if the message is associated with the disposable email address, a means for routing the message to the disposable email address based on routing option means.
